(19) United States
(12) Patent Application Publication
(10) Pub. No.: US 2008/0271156 A1
(43) Pub. Date: Oct. 30, 2008

(54) METHODS AND SYSTEMS FOR SEARCHING PROTECTED DIGITAL CONTENT AND NON-PROTECTED DIGITAL CONTENT

(76) Inventors: Gregory J. Lipinski, Loveland, CO (US); Philip M. Walker, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/742,581

(22) Filed: Apr. 30, 2007

(51) Int. Cl. H04L 9/32; H04L 9/00

(52) U.S. Cl. 726/27; 380/277

(57) ABSTRACT

A system is provided, the system includes a plurality of electronic devices, the electronic devices having protected digital content and non-protected digital content. The system further comprises a server coupled to the plurality of electronic devices. The server selectively searches the protected digital content and the non-protected digital content and provides a uniform view of search results.

### BACKGROUND

Electronic devices store a variety of digital content. Some of the digital content is non-protected (public), while other digital content is protected (private). Due to the amount of digital content that exists on electronic devices and networks, search and collation services have been developed. Existing search and collation services are usually restricted to a subset of searchable digital content. Also, searching protected digital content is problematic.

### BRIEF DESCRIPTION OF THE DRAWINGS

For a detailed description of exemplary embodiments of the invention, reference will now be made to the accompanying drawings in which:

FIG. 1 illustrates a computer in accordance with embodiments;

FIG. 2 illustrates a system in accordance with embodiments; and

FIG. 3 illustrates a method in accordance with embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As disclosed herein, embodiments provide a search manager that is capable of simultaneously searching protected (private) digital content and non-protected (public) digital content. Protected digital content corresponds to digital content that a user is authorized to view after an authentication process is successfully completed. In some embodiments, the search manager runs on a home server and enables searching and collation of digital content of electronic devices that form part of a home network. As used herein, a “home server” and “home network” refers to a server and network that is physically close to a user (e.g., within the user's home or building). The search manager also enables searching and collation of online digital content (from remote websites), even if the online digital content is private (e.g., an authentication process such as login is required). In some embodiments, a user has established a relationship with the remote website by setting up an account or bookmarking the website. As needed, the search manager can automatically handle account logins, encryption/decryption of data, or other security processes needed to search, collate and display protected digital content from local clients or remote websites.

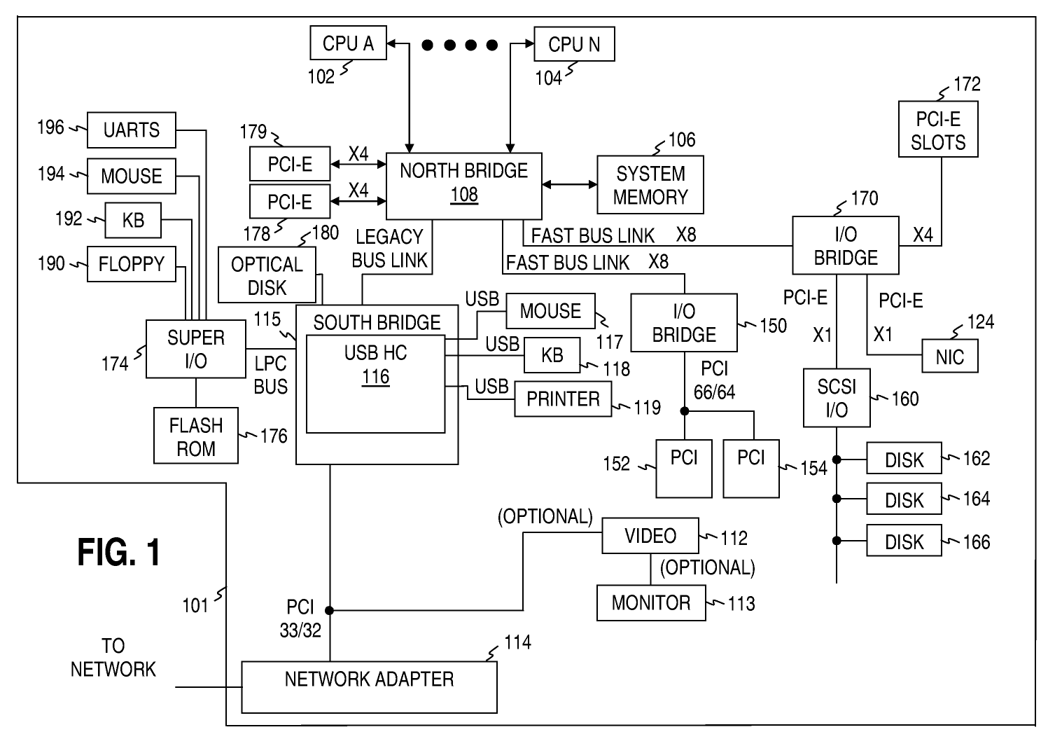

Referring now to the drawings and in particular to FIG. 1, there is shown a computer 101 in accordance with embodiments of the disclosure. The computer 101 corresponds to a client computer or a server computer. In at least some embodiments, the server computer is a headless server (without a dedicated human interface such as a monitor, a keyboard or a mouse). As shown, the computer 101 comprises a plurality of central processing units (CPUs) 102, 104 coupled to a bus bridge, commonly referred to in the computer industry as a “North Bridge” 108. The North Bridge 108 couples the CPUs 102, 104 to system memory 106 and to other components of the computer 101. The North Bridge 108 has a significant impact on the computer's performance given that it defines the speed at which data flows between the CPUs 102, 104 and the system memory 106.

As shown, the North Bridge 108 couples to an input/output (I/O) bridge 150 via a “fast” serial bus link (compared to a legacy bus link) having, in some embodiments, eight serial communication channels (×8). This bus may be a proprietary chipset interconnect or may be consistent with an established industry standard such as PCI-Express. In at least some embodiments, the I/O bridge 150 couples to PCI slots 152, 154 via a PCI 66/64 communication interface. The PCI slots 152, 154 may be configured to support insertable/removable PCI cards that enhance the functionality of the computer 101.

The North Bridge 108 also couples to an I/O bridge 170 via another “fast” bus link (compared to a legacy bus link) having, in some embodiments, eight communication channels (×8). As shown, the I/O bridge 170 couples to a Small Computer System Interface (SCSI) module 160 via a PCI Express (PCI-E) communication bus. The SCSI module 160 supports several storage disks 162, 164, 166 based on a SCSI communication protocol. The I/O bridge 170 also couples to a Network Interface Card (NIC) 124 via a PCI-E communication bus. The NIC 124 enables the computer 101 to communicate with other computers or network devices based on a network communication protocol such as Ethernet or Transmission Control Protocol/Internet Protocol (TCP/IP). The I/O bridge 170 also couples to PCI-E slots 172 (e.g., via a communication bus having, in some embodiments, four communication channels (×4)). The PCI-E slots are configured to support insertable/removable PCI-E cards that enhance the functionality of the computer 101. Those skilled in the art will appreciate that the width of the fast bus links as well as PCI-E connections for slots and devices are chosen based on the anticipated bandwidth of the connected devices. Other interconnects as well as other lane widths may be chosen by the system designer.

As shown, the North Bridge 108 also couples to a South Bridge 115 via a legacy communication bus link. This bus link may be a proprietary chipset interconnect or may be consistent with an established industry standard such as PCI-Express. In at least some embodiments, the South Bridge 115 comprises a USB host controller 116 that couples to and supports USB peripheral devices such as a USB mouse 117, a USB keyboard (KB) 118 and a USB printer 119. Those skilled in the art will appreciate that these devices may be coupled through USB connectors and are optional. The South Bridge 115 also couples to and supports an optical disk drive 180 (e.g., a CD-ROM or DVD-ROM drive). The South Bridge 115 also couples to a Super input/output (I/O) interface 174 via a low-pin-count (LPC) bus. The Super I/O (SIO) 174 couples to and supports a Flash ROM 176 as well as a floppy drive 190, a legacy keyboard (KB) 192, a legacy mouse 194 and Universal Asynchronous Receiver/Transmitters (UARTs) 196. Like the USB devices mention above, the SIO 174 provides interfaces to which the enumerated legacy devices may be attached. The presence of a physical legacy keyboard or mouse may not be required for proper operation of the computer 101.

As shown, the South Bridge 115 optionally couples to and supports a video card 112 which optionally couples to a monitor 113. For example, if the computer 101 corresponds to a client, the video card 112 and monitor 113 could be included. If the computer 101 corresponds to a headless server, the video card 112 and monitor 113 could be excluded. If the computer 101 corresponds to a home server, the video card 112 and monitor 113 could be optional. In other words, the home server could be headless or not. As previously mentioned, a home server refers to a server and that is physically close to a user (e.g., within the user's home or building).

The South Bridge 115 also couples to and supports a network adapter 114 via a PCI 33/32 communication bus. Alternatively, the network adapter 114 may be coupled to the host via another suitable communication interface such as PCI-Express, PCI-X, 66/64, LPC, or the like. The network adapter 114 enables the computer 101 to communicate with a printer on a network.

In at least some embodiments, the computer 101 stores protected or non-protected digital content in the form of data files, multi-media, applications, or other digital content. The digital content is stored by a computer-readable medium corresponding to the system memory 106, the disks 612, 164, 166, or the optical disk 180 mentioned previously. In general, storage of the digital content may be provided through at least one of secondary storage, read only memory (ROM), random access memory (RAM), or another storage medium now known or later developed. As an example, secondary storage comprises one or more disk drives or tape drives and is used for non-volatile storage of data and as an over-flow data storage device if RAM is not large enough to hold all working data. Secondary storage may be used to store programs that are loaded into RAM when such programs are selected for execution. ROM is used to store instructions and perhaps data that are read during program execution. ROM is a non-volatile memory device that typically has a small memory capacity relative to the larger memory capacity of secondary storage. RAM is used to store volatile data and perhaps to store instructions. Access to both ROM and RAM is typically faster than to secondary storage.

Because the quantity of digital content of the computer 101 is often high, the ability to search and collate digital content (protected and non-protected) is important. To support search and collation of protected and non-protected digital content, the computer 101 either runs a search manager application or cooperates with another device that runs a search manager application. In either case, the search manager application is able to simultaneous search protected and non-protected information. The search results are presented to the user at the same time via a visual interface provided by the search manager application. In some embodiments, the search results have a uniform appearance regardless of whether the digital content is protected or non-protected. Also, the search manager application supports generation and updating of indexes for the protected digital content and non-protected digital content. To support accessing protected digital content, the search manager application also enables generation and updating of security information related to the protected information. For example, in some embodiments, the search manager application enables account information, login information, passwords, encryption keys, or other security information to be indexed and updated. When accessing the protected digital content, the search manager application is able to communicate with any security interfaces related to the protected digital content and subsequently gain access to the protected digital content based on the indexed security information. The process by which the search manager application accesses and searches protected and non-protected digital content is preferably transparent to the user. In some cases, a user may need to provide some of the security information to the search manager application.

Embodiments of clients and servers are not limited to the computer 101 of FIG. 1. FIG. 1 simply illustrates one embodiment. Alternative embodiments vary with respect to processing, memory, interconnects, protocols, peripherals and other functional aspects. In some embodiments, the computer 101 represents at least one device of a home network having a home server, a hNAS (or other digital storage devices), desktop computers, laptop computers, multi-media devices, mobile devices or other devices. Such devices may be suitably employed to receive, access, or generate protected and non-protected digital content that can be searched and collated by a search manager application. The search manager application either displays search results on a monitor coupled to the electronic device running the search manager application or displays search results on another device (e.g., any device capable of receiving the search results and displaying these results to a user). The electronic device running the search manager application is local to or remote from the electronic devices having the protected digital content or non-protected digital content.

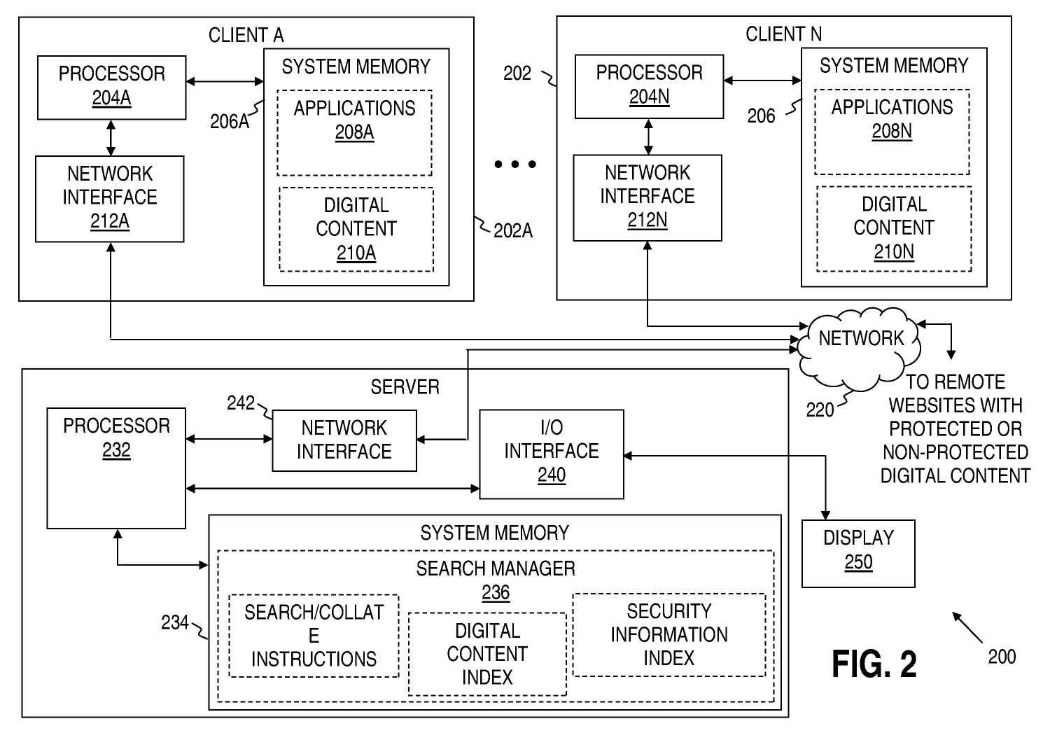

FIG. 2 illustrates a system 200 in accordance with embodiments. As shown, the system 200 comprises a plurality of clients 202A-202N that couple to a server 230 via a network 220. The components of the clients 202A-202N, the network 220, and the server 230 have been simplified to facilitate describing embodiments. In various embodiments, the clients 202A-202N and the server 230 have more or less of the components described for the computer 101 of FIG. 1. As an example, the clients 202A-202N represent desktop computers, laptop computers, multi-media devices (video or music storage devices), mobile devices (cell phones or PDAs) or other devices in a home network. In alternative embodiments, the clients 202A-202N represent devices within a remote network. In at least some embodiments, the server 230 is in communication with remote websites as well as a home network.

A representative description of each client will be provided by describing the client 202A. As shown in FIG. 2, the client 202A comprises a processor 202A coupled to a system memory 206A. The processor 202A also couples to a network interface 212A.

In at least some embodiments, the system memory 206A is a computer-readable medium that stores applications 208A, which are executable by the processor 202A. The system memory 206A also stores digital content 210A, which may be in the form of data files, multi-media, applications, or other digital content. The system memory 206A corresponds to at least one of secondary storage, ROM, RAM, or another storage medium now known or later developed. When executed, at least one of the applications 208A enables the client 202A to receive, access or generate additional digital content 210A. The digital content 210A is protected or non-protected. If the digital content 210A is protected, account information, login information, passwords, encryption keys or other security information may be employed before access to the protected digital content is possible. As an example, in some embodiments, one of the applications 208A enables the client 202A to download protected or non-protected digital content from the internet or to generate and store protected or non-protected digital content locally. As needed, at least one of the applications 208A cooperates with the server 230 to enable access, searching or collation of the digital content 210A.

As shown in FIG. 2, the server 230 comprises a processor 232 coupled to a system memory 234 that stores a search manager application 236. In at least some embodiments, the search manager application 236 comprises search/collate instructions 237, a digital content index 238 and a security information index 238. The system memory 234 corresponds to at least one of secondary storage, ROM, RAM, or another storage medium now known or later developed. The processor 232 also couples to an I/O interface 240 which selectively couples to a local peripheral device such as a display 250 or other peripheral device. If the server 230 corresponds to a headless server, the I/O interface 240 can be omitted. In such case, the search manager application is able to present search results on an electronic device coupled to the server 230.

The processor 232 also couples to a network interface 242. The network interface 242 enables the server 230 to communicate with devices on the network 220 and corresponds, for example, to an Ethernet network with TCP/IP. As shown, the server 230 communicates to the clients 202A-202N via the network interface 234. The communication is wired, wireless, or a combination of wired and wireless communication. Also, the server 230 is able to communicate with remote websites. In some cases, a user of the server 230 has established a relationship with the remote websites by setting up an account or bookmarking the website.

When executed, the search/collate instructions 237 cause the processor 232 to search for and collate the digital content 210A-210N. Protected and non-protected digital content may also be searched for and collated from the remote websites. As an example, the search/collate instructions 237 enables the server 230 to communicate with the clients 202A-202N or with the remote websites to search and collate digital content. Additionally or alternatively, the clients 202A-202N or remote websites sends prompts to the server 230 and/or mark digital content to assist the server 230 in its task to find and index the digital content 210A-210N. As the search progresses, the search/collate instructions 237 cause the processor 232 to generate the digital content index 238. As an example, each entry of the digital content index 238 contains digital content information such as file name, file type, file location, creation date, modification date, protection status or other information. This information can be stored to facilitate future searches and/or to notify a user when changes are made to the digital content information. In at least some embodiments, the digital content index 238 is periodically updated (either automatic or user prompted).

When executed, the search/collate instructions 237 also establishes a security information index 239. As an example, each entry of the security information index 239 contains account information, login information, passwords, encryption keys or other security information related to protected digital content. In at least some embodiments, the security information relates to security processes or applications of the clients 202A-202N or of the remote website. In either case, the security information enables the search/collate instructions 237 to access protected digital content from the clients 202A-202N or from the remote websites. As needed, the search/collate instructions 237 cause the processor 232 to access and/or update the security information index 239 in order to gain access to protected digital content. Security information entries are added or deleted as needed. In at least some embodiments, a user participates in providing security information, although some automation and/or cooperation with remote websites is also possible.

The scope of relevant digital content relates not only to personal files (e.g., music, movies, documents, email) on home-based client devices, but also corresponds to material outside a home network. For example, archival copies of digital content, photos uploaded to a digital photo service, or other digital content outside a home network are searched/collated by the search manager application 236. These materials are provided via the remote websites. In at least some embodiments, the search/collate instructions 237 support login accounts of a domain server or non-domain login accounts (specific to an operating system or other application). Whether local or remote, account accesses and logins are performed by the search/collate instructions 237 to access protected digital content.

Although not required, account accesses and logins can be transparent to the user (i.e., the user does not see the login event). Also, search results generated by the search manager application 236 can be displayed to a user in a uniform manner (regardless of the location or protection status of the digital content). In at least some embodiments, the search manager application 236 is compatible with devices that run differing operating systems (WINDOWS, LINUX, or APPLE) and/or non-PC devices (e.g., TIVO, IPODS).

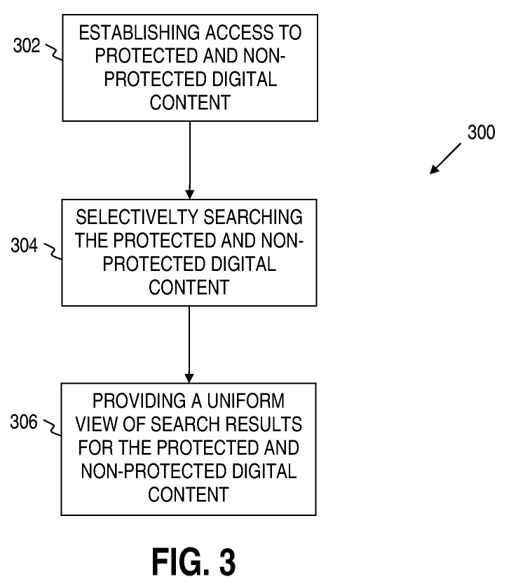

FIG. 3 illustrates a method 300 in accordance with embodiments. The method 300 comprises establishing access to protected and non-protected digital content (block 302). In some embodiments, a server having a search manager application searches for protected and non-protected digital content on clients or remote websites. As needed, security information is utilized to provide access to the protected digital content. At block 304, the method 300 selectively searches the protected and non-protected digital content. The searching process of protected and non-protected digital content is simultaneous or at least appears to a user to be simultaneous. At block 306, the method 300 provides a uniform view to the user of search results for the protected and non-protected digital content. The method 300 can also comprise processes for cooperative search efforts among a server, the server's clients and remote websites, processes for indexing and updating digital content, and processes for indexing and updating security information.

What is claimed is:

1. A system, comprising:
a plurality of electronic devices, the electronic devices having protected digital content and non-protected digital content; and
a server coupled to the plurality of electronic device,
wherein the server selectively searches the protected digital content and the non-protected digital content and provides a uniform view of search results.

2. The system of claim 1 wherein the server comprises a headless server.

3. The system of claim 1 wherein the server stores an index of the protected and non-protected digital content and periodically updates said index.

4. The system of claim 1 wherein at least some of the electronic devices are local to the server.

5. The system of claim 1 wherein at least some of the protected digital content is provided by a remote website.

6. The system of claim 1 wherein the server stores security information related to the protected digital content and uses the security information to selectively access the protected digital content.

7. The system of claim 1 wherein the server stores a security information index related to the protected digital content and periodically updates said security information index.

8. The system of claim 1 wherein the server stores encryption keys related to protected digital content and uses the encryption keys to selectively access the protected digital content.

9. The system of claim 1 wherein the server stores an encryption key index and periodically updates said encryption key index.

10. A method, comprising:
establishing simultaneous access to protected and non-protected digital content; and
selectively searching the protected and non-protected digital content.

11. The method of claim 10 further comprising providing a uniform view of search results of the protected and non-protected digital content.

12. The method of claim 10 further comprising performing said establishing access and said selectively searching with a headless server.

13. The method of claim 10 further comprising accessing protected digital content on a remote website by transparently logging onto an account.

14. The method of claim 10 further comprising storing an index of the protected and non-protected digital content and periodically updating said index.

15. The method of claim 10 further comprising storing an account information index related to the protected digital content and periodically updating said account information index.

16. The method of claim 10 further comprising storing an encryption key index related to the protected digital content and periodically updating said encryption key index.

17. A computer-readable medium storing a search manager application, the search manager application, when executed, causes a processor to:
establish simultaneous access to protected digital content and non-protected digital content; and
selectively search the protected and non-protected digital content.

18. The computer-readable medium of claim 17 wherein the search manager application further causes the processor to access the protected digital content by automatically logging onto a remote website account.

19. The computer-readable medium of claim 17 wherein the search manager application further causes the processor access protected generate an index of the protected and non-protected digital content and to periodically update said index.

20. The computer-readable medium of claim 17 wherein the search manager application further causes the processor to generate an account information index related to the protected digital content and to periodically update said account information index.

21. The computer-readable medium of claim 17 wherein the search manager application further causes the processor to generate an encryption key index related to the protected digital content and to periodically update said encryption key index.

22. The computer-readable storing of claim 17, wherein the computer-readable medium is stored and executed by a headless server.
